(19) United States
(12) Patent Application Publication
(10) Pub. No.: US 2025/0332572 A1
(43) Pub. Date: Oct. 30, 2025

(54) MODIFICATION OF WOVEN MATERIALS WITH MOISTURE-SWING MOIETIES FOR CO2 CAPTURE

(71) Applicants: Arizona Board of Regents on behalf of Arizona State University, Scottsdale, AZ (US); The Board of Regents of The University of Texas System, Austin, TX (US)

(72) Inventors: Marlene Velazco Medel, Tempe, AZ (US); Kacie Niimoto, Mesa, AZ (US); Matthew Green, Phoenix, AZ (US); Benny Freeman, Austin, TX (US); Deepak Narayana Murthy Akundi, Tempe, AZ (US)

(21) Appl. No.: 19/193,894

(22) Filed: Apr. 29, 2025

Related U.S. Application Data
(60) Provisional application No. 63/640,844, filed on Apr. 30, 2024.

(51) Int. Cl. B01J 20/32; B01D 53/02; B01J 20/26; B01J 20/28; D06M 15/356; D06M 101/26

(52) U.S. Cl. CPC B01J 20/328; B01D 53/02; B01J 20/26; B01J 20/28033; B01J 20/3208; D06M 15/3562; B01D 2253/202; B01D 2253/25; B01D 2257/504; B01D 2258/06; D06M 2101/26; D06M 2200/00

(57) ABSTRACT

A modified textile sorbent (MTS) material for direct capture of atmospheric CO₂, and method for producing the same is disclosed. The MTS material includes a woven material and a sorbent polymer immobilized within the woven material, with the sorbent polymer having a plurality of swing-responsive moieties that respond to at least one of a temperature swing, a pressure swing, and a moisture swing. The method for producing a MTS material includes mixing a monomer of a sorbent polymer, in solution, with a woven material such that the monomer is impregnated into the woven material. The method also includes immobilizing the sorbent polymer within the woven material by polymerizing the monomer that is impregnated into the woven material. and substituting a counterion of the sorbent polymer with a swing-responsive moiety. The monomer is one of styrene-based, acrylate-based, methacrylate-based, silicone-based, or polysulfone-based.

### RELATED APPLICATIONS

This application claims the benefit of U.S. provisional patent application 63/640,844, filed Apr. 30, 2024 titled “Modification of Textiles with Moisture-Swing Moieties for CO₂ Capture,” the entirety of the disclosure of which is hereby incorporated by this reference.

### STATEMENT REGARDING FEDERALLY SPONSORED RESEARCH

This invention was made with government support under DE-SC0023343 awarded by the Department of Energy. The government has certain rights in the invention.

### TECHNICAL FIELD

Aspects of this document relate generally to carbon dioxide capture materials.

### BACKGROUND

The substantial rise in carbon dioxide (CO₂) emissions during the 20th century has emerged as a leading cause of severe climate changes and the subsequent increase in global temperatures. This pressing issue has spurred the rapid advancement of technologies and methodologies aimed at combating the escalating concentration of CO₂ in the Earth's atmosphere. Notably, extensive research is underway in the field of Direct Air Capture (DAC) to devise diverse techniques and sorbents capable of directly capturing CO₂ from the ambient air.

Recent research developments in the field of carbon capture and storage (CCS) have introduced many technologies focusing on the capture of dilute CO₂ directly from the atmosphere, beyond point source capture techniques. These DAC technologies are needed to reduce the CO₂ content in the atmosphere and avoid global temperature growth by about 1.5° C. by 2050, as mentioned in IPCC A1FI report.

Out of the many available DAC technologies, sorption-based methods and materials show promising results. Chemisorption and physisorption are the two broadly classified mechanisms for CO₂ sorption. The regeneration of these materials (i.e., the desorption of captured CO₂) can be achieved by altering different operating conditions like temperature (i.e., temperature-swing), pressure (i.e., pressure-vacuum swing), and humidity (i.e., moisture-swing). In terms of capture capacity, ease of regeneration, etc., the above-mentioned sorption mechanisms have their own advantages and disadvantages. For example, a moisture-swing approach, typically using strong base ion-exchange resins as the sorbents, has better capture capacity than chemisorption and has lower energy requirements for regeneration compared to physisorption.

While fighting global warming is an important goal, it is more likely that the widespread adoption and use of DAC devices will be driven by shorter term economic goals and benefits. This means that the DAC devices need to be economically attractive, operating within a tight energy budget with low capital and operating costs.

Although the sorption-based methods discussed above have many attractive qualities, there are some downsides. Conventional sorbent materials tend to have short lifespans due to the operating temperatures. Some of the best performing materials have mechanical shortcomings, making them fragile and/or difficult to manufacture at a commercial scale. Periodically having to repair or replace these materials increases costs and required downtime of the DAC devices. Additionally, the efficiency of these sorbent materials has room for improvement; better performance can have a large impact on the economics of DAC systems.

### SUMMARY

According to one aspect, a method for producing a sorbent material for CO₂ capture includes mixing a monomer of at least one sorbent polymer, in solution, with a woven material such that the monomer is impregnated into the woven material, and immobilizing the at least one sorbent polymer within the woven material by polymerizing the monomer of the at least one sorbent polymer that is impregnated into the woven material. The method also includes substituting a counterion of each sorbent polymer of the at least one sorbent polymer with a swing-responsive moiety. The monomer of each sorbent polymer of the at least one sorbent polymer is one of styrene-based, acrylate-based, methacrylate-based, silicone-based, or polysulfone-based.

Particular embodiments may comprise one or more of the following features. The swing-responsive moiety responds to at least one of a temperature swing, a pressure swing, and a moisture swing. The counterion may be one of chloride, bromide, and iodide. The swing-responsive moiety may be one of carbonate and phosphate. The monomer of the at least one sorbent polymer may include at least one of a quaternary ammonium functional group, a phosphonium functional group, and an imidazolium functional group. The woven material may be hydrophobic. The woven material may be acrylic fabric. The monomer may be VBTEA. The woven material may include at least one of polyester, polyacrylate, polyamide, and cotton.

According to another aspect of the disclosure, a method for producing a sorbent material for CO₂ capture includes mixing a monomer of a sorbent polymer, in solution, with a woven material such that the monomer is impregnated into the woven material, and immobilizing the sorbent polymer within the woven material by polymerizing the monomer that is impregnated into the woven material. The method also includes substituting a counterion of the sorbent polymer with a swing-responsive moiety that responds to a moisture swing. The counterion is chloride. The monomer of the sorbent polymer is styrene-based and comprises a quaternary ammonium functional group.

Particular embodiments may comprise one or more of the following features. The woven material may be hydrophobic. The woven material may be acrylic fabric. The monomer may be VBTEA. The woven material may include at least one of polyester, polyacrylate, polyamide, and cotton.

According to yet another aspect of the disclosure, a sorbent material for CO₂ capture includes a woven material and at least one sorbent polymer immobilized within the woven material. The at least one sorbent polymer includes a plurality of swing-responsive moieties that respond to at least one of a temperature swing, a pressure swing, and a moisture swing.

Particular embodiments may comprise one or more of the following features. The at least one sorbent polymer may include at least one of a plurality of quaternary ammonium functional groups, a plurality of phosphonium functional groups, and a plurality of imidazolium functional groups. The woven material may be hydrophobic. The woven material may be acrylic fabric. A monomer of the at least one sorbent polymer may be VBTEA. The woven material may include at least one of polyester, polyacrylate, polyamide, and cotton.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1 is a schematic view of the synthesis of a modified textile sorbent (MTS) material;

FIGS. 2A and 2B are schematic views of monomers that are styrene- and methacrylate-based, respectively;

FIG. 3 is a schematic view of the synthesis of a monomer precursor to an MTS material;

FIG. 4 is a schematic view of the polymerization of a monomer having been impregnated into a woven material, resulting in an MTS material;

FIG. 5 shows the Infrared-Attenuated Total Reflectance Spectroscopy (IR-ATR) transmittance of pristine acrylic fabric, MTS-CI, MTS-HCO3, and PVBTEA;

FIG. 6 shows thermogravimetric analysis (TGA) results for the pristine fabric, MTS-Cl, and PVBTEA discussed with respect to FIG. 5;

FIG. 7 shows the stress-strain behavior of the pristine fabric and MTS-Cl discussed with respect to FIGS. 5 and 6;

FIG. 8 shows SEM images of the pristine fabric and MTS-Cl discussed with respect to FIGS. 5-7;

FIG. 9 is a schematic view of a closed-circuit, humidity swing CO₂ adsorption-desorption system used to quantify the performance of an MTS material implemented within a DAC device;

FIG. 10 shows CO₂ adsorption and desorption performance of an MTS material observed with the closed-circuit DAC system of FIG. 9; and

FIG. 11 shows the average uptake capacity of the MTS material observed with the closed-circuit DAC system of FIG. 9.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

The substantial rise in carbon dioxide (CO₂) emissions during the 20th century has emerged as a leading cause of severe climate changes and the subsequent increase in global temperatures. This pressing issue has spurred the rapid advancement of technologies and methodologies aimed at combating the escalating concentration of CO₂ in the Earth's atmosphere. Notably, extensive research is underway in the field of Direct Air Capture (DAC) to devise diverse techniques and sorbents capable of directly capturing CO₂ from the ambient air.

Recent research developments in the field of carbon capture and storage (CCS) have introduced many technologies focusing on the capture of dilute CO₂ directly from the atmosphere, beyond point source capture techniques. These DAC technologies are needed to reduce the CO₂ content in the atmosphere and avoid global temperature growth by about 1.5° C. by 2050, as mentioned in IPCC A1FI report.

Out of the many available DAC technologies, sorption-based methods and materials show promising results. Chemisorption and physisorption are the two broadly classified mechanisms for CO₂ sorption. The regeneration of these materials (i.e., the desorption of captured CO₂) can be achieved by altering different operating conditions like temperature (i.e., temperature-swing), pressure (i.e., pressure-vacuum swing), and humidity (i.e., moisture-swing). In terms of capture capacity, ease of regeneration, etc., the above-mentioned sorption mechanisms have their own advantages and disadvantages. For example, a moisture-swing approach, typically using strong base ion-exchange resins as the sorbents, has better capture capacity than chemisorption and has lower energy requirements for regeneration compared to physisorption.

While fighting global warming is an important goal, it is more likely that the widespread adoption and use of DAC devices will be driven by shorter term economic goals and benefits. This means that the DAC devices need to be economically attractive, operating within a tight energy budget with low capital and operating costs.

Although the sorption-based methods discussed above have many attractive qualities, there are some downsides. Conventional sorbent materials tend to have short lifespans due to the operating temperatures. Some of the best performing materials have mechanical shortcomings, making them fragile and/or difficult to manufacture at a commercial scale. Periodically having to repair or replace these materials increases costs and required downtime of the DAC devices. Additionally, the efficiency of these sorbent materials has room for improvement; better performance can have a large impact on the economics of DAC systems.

Contemplated herein are modified textile sorbent materials for capturing CO₂ directly from ambient air, and methods for producing the same. The contemplated modified textile sorbent materials (hereinafter MTS material) are advantageous over conventional sorbents by having enhanced mechanical and thermal properties resulting in greater durability and longer functional lifespan. Their enhanced mechanical properties facilitate their integration with a broader range of applications and use environments where the use of conventional sorbent materials would be impractical, if even possible.

Current state of the art DAC uses temperature-swing sorbents that have a minimum regeneration temperature of 100° C. While these sorbents perform well, they have a limited operational life due to thermal degradation. Some embodiments of the contemplated MTS materials are moisture-swing materials, and are able to operate at lower temperatures without sacrificing performance. Their increased stability leads to a longer usable lifespan.

Many moisture-swing sorbents are water-soluble when polymerized as linear polymers, which limits their use in humid conditions. The addition of crosslinkers during the synthesis can result in polymeric networks with better physical and chemical properties, but still their use is limited by the high-water uptake in ambient air, which decreases the adsorption/desorption performance, and which also drives the formation of hydrogels that decrease the gas diffusion.

According to various embodiments, through the use of a woven support material and moderate crosslinking, sorbent polymers that would typically dissolve are able to be utilized in a moisture-swing DAC device through their incorporation into an MTS material using the methods contemplated herein. The immobilization of a sorbent polymer within a woven material that is hydrophobic nature (e.g., acrylic fabric, etc.) will decrease water uptake, thereby allowing a faster drying time and increasing adsorption/desorption performance. At the same time, the woven material increases the surface area, transport, and gas diffusion to the sorbent. For applications such as gas permeation and diffusion, the surface area is an important aspect. The immobilization of water-soluble polymers or hydrogels into a woven backing provides a good solution for their handling and application.

The approach of embedding or immobilizing a polymer into a polymeric textile support material (e.g., woven material, fibrous material, etc.) may benefit one aspect of the polymer without degrading another. For example, the adsorption capacity of a sorbent material depends on the chemical properties of the sorbent, whereas the adsorption kinetics depend on the physical properties of the sorbent like pore structure and size. According to various embodiments, the use of a woven substrate as support for sorbent polymers can provide mechanical strength and load distribution without interfering with the chemical properties.

Additionally, the benefits of the contemplated MTS material architecture do not come at the expense of performance. According to various embodiments, the MTS materials contemplated herein exhibit better mass/CO₂ transport properties than conventional sorbents. As a specific example, in one embodiment, an MTS material exhibits a CO₂ loading of 1.2 mmol per gram of material. The incorporation of a hydrophobic woven material can lead to faster drying, thereby shortening the period of the moisture-swing capture/release cycle and increasing the output of a DAC device.

In some embodiments, the MTS material may be a composite material. Specifically, the woven material may be physically or chemically modified, with a modification degree of 10%, 20%, 30%, or more, in mass of DAC sorbent, according to various embodiments. In other embodiments, the MTS material may be a hybrid material, a blending of the active polymer and the woven material.

The MTS material contemplated herein harnesses useful properties of both the woven material and the sorbent polymer immobilized within it. However, both materials have disadvantages that need to be balanced, in some embodiments. For example, using too much of the sorbent polymer will result in a material that is brittle and fragile when dry and that takes on too much water when wet, slowing the moisture swing cycle. However, too little sorbent will yield a DAC device that is inefficient in capturing carbon dioxide. A preferred ratio of the materials varies among embodiments, depending on which materials are being used.

It should be noted that while much of this disclosure is done in the context of using the contemplated materials in direct air capture devices, those skilled in the art will recognize that these materials, which have advantageous chemical and mechanical properties, may be adapted for use in other types of capture devices known in the art including, but not limited to, both passive and active capture devices. Furthermore, the methods contemplated herein may be adapted for use in introducing sorbents or other materials into fabrics and membranes. Although much of the following discussion is done in the context of a DAC device, the contemplated materials and methods are not limited to just that particular application.

The MTS materials contemplated herein are made up of a sorbent polymer immobilized within a woven material. In some embodiments, the woven material has been modified using sorbent polymers that are moisture-swing active, which provides an avenue for energy-efficient DAC devices. The widespread adoption of DAC devices will require that they can operate within a very tight energy budget, to make their operation economically feasible. In other embodiments, the MTS materials may exhibit other forms of adsorption/desorption activity, apart from moisture-swing. Examples include temperature-swing, pressure-swing, and the like.

As discussed above, MTS materials comprise woven fabrics and ion-exchange materials that have been modified with sorbents that, in some embodiments, are moisture-swing active for CO₂ adsorption/desorption. According to various embodiments, the immobilization of sorbents with moisture-swing behavior into the fabric increases the stability of the material, while the support provides mechanical and thermal stability as well as high sorbent distribution, improving DAC performance.

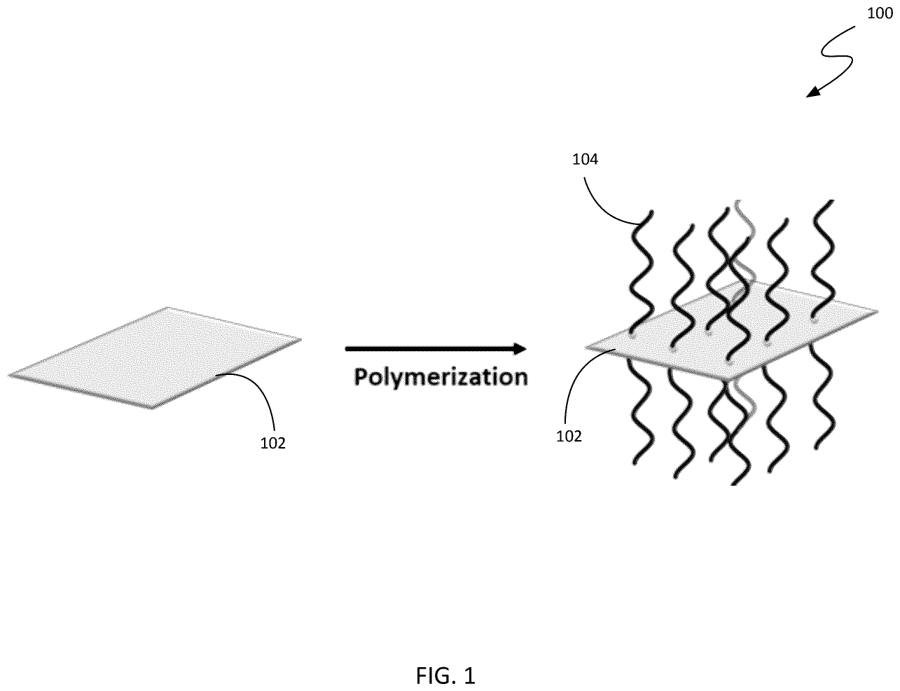

FIG. 1 is a schematic view of the creation of a non-limiting example of a modified textile sorbent (MTS) material. According to various embodiments, the MTS materials 100 are produced through the immobilization of a sorbent polymer 104 within a woven material 102 through the entanglement of the polymer in the fibers of the textile. It should be noted that while the following discussion is focused on polymerization after monomer impregnation through conventional free radical polymerization to achieve this entanglement, those skilled in the art will recognize that other mechanisms may be employed to achieve the same, or similar, immobilization, including but not limited to chemical grafting and simple mixing to form hybrid materials.

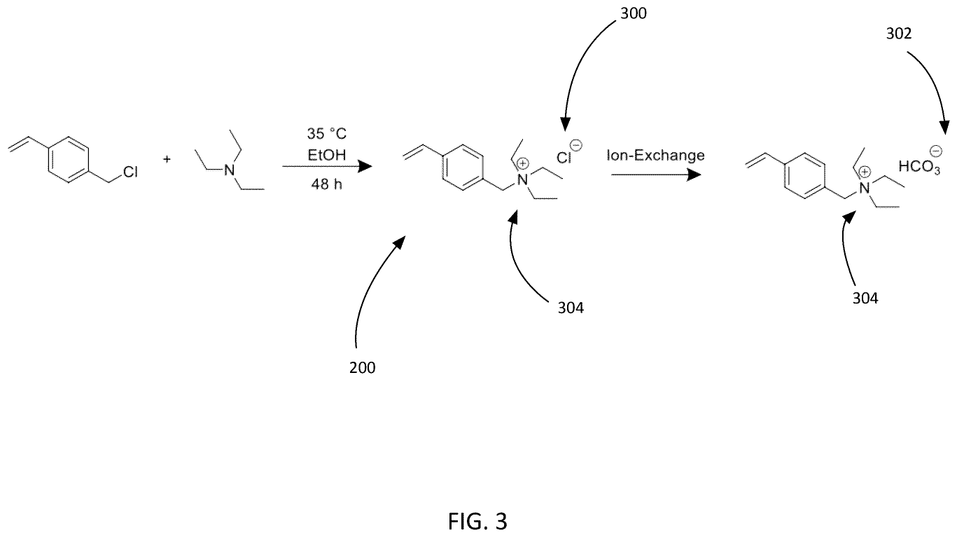

The MTS materials 100 contemplated herein comprise at least one sorbent polymer 104 that has been immobilized within a woven material 102. Sorbent polymers 104 that are well adapted for use in CO₂ DAC systems and that can be implemented as part of an MTS material 100 include, but are not limited to, polymers that are styrene-, acrylate-methacrylate-, silicone-, or polysulfone-based and having quaternary ammonium, phosphonium, or/and imidazolium functionalities. As is known in the art, these functional groups are where the carbon dioxide is captured and released. According to various embodiments, ion exchange can be used to replace a counterion at these sites with a swing-responsive moiety that makes the sorbent polymer 104 (and resulting MTS material 100) responsive to changes in one or more environmental aspects including, but not limited to, temperature (i.e., temperature swing), humidity (i.e., moisture swing), pressure (i.e., pressure swing), and the like. This will be discussed in greater detail with respect to FIG. 3, below.

As a specific example, in one embodiment, the sorbent polymer 104 is a polystyrene-based moisture-swing sorbent. Though it performs well as a sorbent, it is highly hydrophilic and, in some variations, water soluble, which makes the moisture-swing cycle complicated. However, immobilizing this polymer in a woven material 104, using a small amount (e.g., 5%, etc.) of crosslinker, not only can the resulting MTS material be handled, it performs better than an equal amount of the sorbent polymer 102 by itself.

According to various embodiments, the MTS materials 100 contemplated herein comprise at least one sorbent polymer 104 immobilized within a textile. While the following discussion of MTS materials 100 will focus on embodiments where the textile is a woven material 102 is made of interlacing fibers (e.g., fabric made of woven polymer, etc.), it should be noted that in the context of the present description and the claims that follow, a textile refers to any self-supporting material that contains a network of through-voids or interstitial passages sufficient to enclose and/or constrain parts of a sorbent polymer 104, thereby immobilizing it with respect to the textile. Thus, it should be noted that while some embodiments immobilize the sorbent polymer within a woven material, other embodiments may instead use a textile that may not be woven.

Capturing the sorbent polymer 104 using these through-voids rather than simply bonding the sorbent polymer 104 to the surface of a substrate allows for higher surface area while also providing structural reinforcement. This results in a sorbent material well adapted for use in DAC applications, having enhanced performance and durability.

In some embodiments, the woven material 102 may be formed through the mechanical processing of fibers. Examples include weaving, knitting, crocheting, or otherwise bonding fibers together in an interlacing manner. In some embodiments the fibers may be synthetic, while in others they may be natural. Examples of polymeric textile fabrics used in various embodiments of the MTS material 100 include, but are not limited to, polyacrylates, polyester, polyamides, nylons, acrylates, cotton, or combinations thereof. As a specific example, in some embodiments the woven material 102 may be an acrylic fabric. In some embodiments, the woven material 102 used in the MTS material 100 may be composed of recycled fabrics and may not require pretreatment.

In other embodiments, the textile may be composed of something other than interlaced fibers that still has the ability to immobilize a sorbent polymer 104 as discussed above. For example, in some embodiments, the textile may be a non-woven membrane.

According to various embodiments, the presence of the woven material 102 allows for higher surface area and enhanced DAC performance of the MTS material 100. In some embodiments, DAC performance is not affected by the composition of the woven material 102 used. In other embodiments, the woven material 102 may be chosen to have properties that further enhance the operation of a DAC device. For example, in some embodiments where the sorbent polymer 104 is a moisture swing sorbent that captures CO₂ when dry and releases CO₂ when wet, using a woven material 102 that is hydrophobic may increase efficiency of the capture/release cycle by preventing the MTS material 100 from becoming overly laden with water. The hydrophobic nature of the woven material 102 may accelerate the drying of the MTS material 100 after regeneration, speeding up the capture/release cycle. The use of a hydrophobic woven material 102 may also result in a more efficient use of water that is pure enough to avoid fouling the sorbent, an expendable resource that can impact the operating budget of the DAC device.

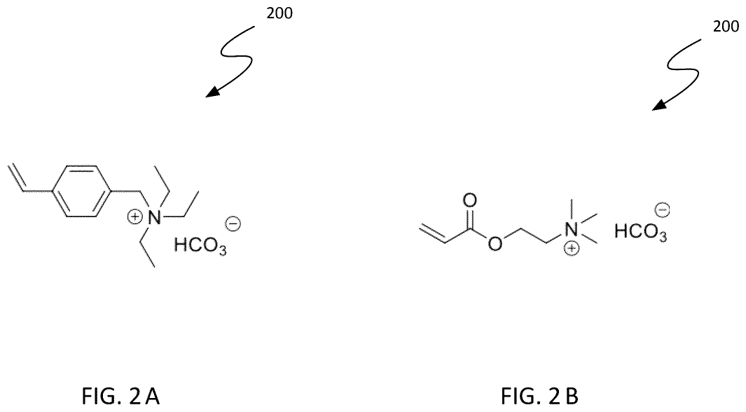

FIGS. 2A and 2B are schematic views of two non-limiting examples of monomers 200 that are styrene-based and methacrylate-based, respectively. According to various embodiments, the modification of the woven material 102 is accomplished using commercial or synthetic monomers 200 of the desired sorbent polymer 104. According to various embodiments, the MTS material 100 may comprise a sorbent polymer 104 made from a monomer 200 that is one of styrene-based, acrylate-based, methacrylate-based, silicone-based, or polysulfone-based. FIGS. 2A and 2B show two examples of monomers 200 with moisture-swing sites. In some embodiments, the synthesis of the monomer 200 may be incorporated into the method for making an MTS material 100.

FIG. 3 is a schematic view of a non-limiting example of the synthesis of a monomer 200 to be used in the creation of an MTS material 100. The following discussion of the methods for modifying a woven material 102 with a sorbent polymer 104 will be presented alongside a specific, non-limiting example of an MTS material 100 and how it is made, where the monomer 200 is styrene-based with a quaternary ammonium functional group 304, and with chloride as the counterion 300. It should be noted that this is a single, non-limiting example, and that in other embodiments, these methods may be adapted for use with other monomers 200, sorbent polymers 104, counterions (e.g., bromide, iodide, etc.) and swing-responsive moieties.

FIG. 3 shows the synthesis of a vinylbenzyl triethylammonium chloride (VBTEA) monomer 200 having a quaternary ammonium functional group 304 as a CO₂ capture site. Other embodiments may utilize a monomer having different functional groups 304 for CO₂ capture including, but not limited to, phosphonium functional groups and imidazolium functional groups. Still other embodiments may comprise styrenic derivatives having quaternary ammonium or phophonium. Additional embodiments may utilize acrylic monomers or methacrylate monomers.

In a specific embodiment that will be used as a non-limiting example throughout this disclosure, this monomer 200 is synthesized by mixing (10.82 g, 10 mL, 70 mmol) chloromethylstyrene (CMS) and (14.52 g, 20 mL, 140 mmol) triethylamine in 40 mL of methanol and stirring overnight at 35° C. For precipitation of the monomer 200, ethyl acetate is used in 4X volume and then filtrated. The white powder is then dried under vacuum at 35° C.

According to various embodiments, the sorbent polymer 104 may require modification to have the desired reactivity to its environment. In some embodiments, the resulting monomer 200 or MTS material 100 may be further modified, exchanging the counterion 300 for something tailored to the intended use case and depending on the type of counterion 300, such as a swing-responsive moiety 302 that responds to a moisture swing, like hydroxide, carbonate (e.g., via ion exchange with KHCO₃, etc.), phosphate (e.g., via ion exchange with K₃PO₄), or other counterions known in the art. According to various embodiments, the substitution may be performed with a swing-responsive moiety 302 that responds to at least one of a temperature swing, a pressure swing, and a moisture swing.

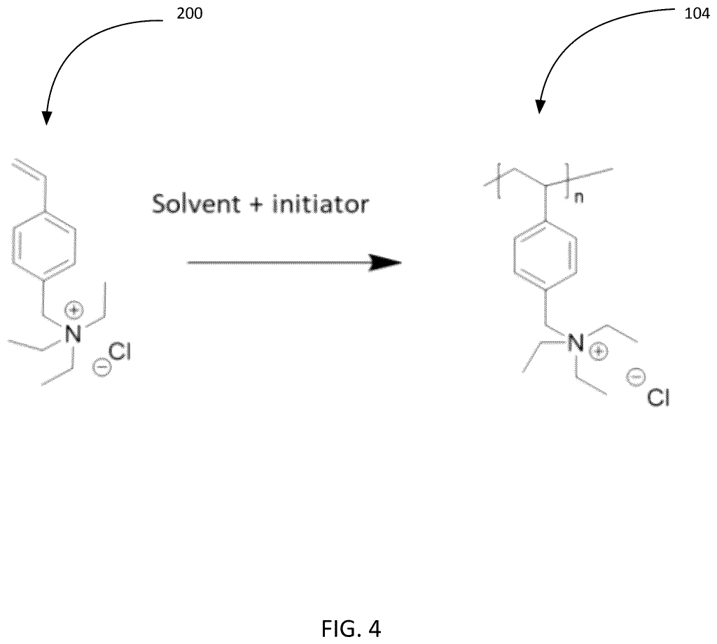

In some embodiments, this exchange may be performed on the monomer 200 before polymerization, while in other embodiments the exchange may be performed on the MTS material 100 (i.e., the counterion exchange is performed on the immobilized sorbent polymer 104). An example of this will be discussed in the context of FIG. 4, below.

FIG. 4 is a schematic view of a non-limiting example of the polymerization of a monomer 200 (having been impregnated into a woven material 102, not shown) resulting in an MTS material 100. According to various embodiments, the process begins with mixing a monomer 200 of at least one sorbent polymer 104, in solution, with a woven material 102 or other textile such that the monomer 200 is impregnated into the woven material 102. The sorbent polymer 104 is then immobilized within the woven material 102 by polymerizing the monomer 200 that is impregnated into the woven material 102, according to various embodiments. Advantageously, in some embodiments, immobilizing the sorbent polymer 104 within the woven material 102 in this manner results in a combination that is robust and able to withstand repeated washings.

Returning to the specific embodiment, the woven material 102 used is acrylic fabric. A 5.5 cm×8.0 cm segment of acrylic fabric was put into a vial with 15 mL DMF:H₂O 6:4 solution of 30% by weight of VBTEA, 2% by weight of DVB, and 2% by weight of AIBN. Crosslinker and initiator were added in ratio with the monomer 200. In some embodiments, the initiator may be a photo initiator. In other embodiments the initiator may be a thermal initiator.

The vial was heated at 70° C. for 24 h under stirring at 100 rpm. After polymerization, the MTS material 100 was rinsed three times in DI water to remove unbounded polymer and unreacted monomers. The modified fabric was then dried under vacuum at 50° C. overnight, yielding an MTS material 100, specifically acrylic fabric@PVBTEA, which will hereinafter be referred to as MTS-Cl.

The degree of modification (DM %) was calculated using the weight difference between pristine fabric (W₀) and MTS-Cl (W_{g}). The general formula is DM (%)=[(W_{g}−W₀)/W₀]100. The difference in thickness of the woven materials before and after the modification was also recorded. In the specific embodiment, the DM % was found to be 30±4%, and the difference in thickness 0.1474±0.009 mm.

In the specific embodiment discussed above, the resulting material MTS-Cl has chloride as a counterion 300. This was put into a mesh bag and soaked in KHCO₃ 0.1 M aqueous solution for 24 hours. This was repeated two more times to ultimately reach complete exchange of chloride into bicarbonate counterion 300. After complete conversion, the material was rinsed in DI water to remove any remaining salt, then dried using high vacuum at 50° C.

In another embodiment, synthesized materials are rinsed with deionized water to remove any loosely bound or unreacted monomers 200 then dried in vacuum overnight to obtain a dry mass. The MTS-Cl is soaked in 0.5M KHCO₃ (carbonate) or K₃PO₄ (phosphate) solution depending on the type of counterion 300 system desired. The effective ion exchange capacity is determined using Hach Chloride strips to measure the concentration of chloride exchanged for the carbonate/phosphate ion. The sample is then rinsed in deionized water to remove any loose ions then vacuum dried overnight.

The following is a discussion of the characterization of the previously discussed specific embodiment of the contemplated MTS material 100. It should be noted that this discussion of the specific properties and performance of this specific embodiment is meant to be illustrative of the advantages provided by the contemplated MTS materials 100, and should not be construed as limiting. As discussed above, other embodiments of the MTS material 100 may comprise different woven material 102 or textile, monomers 200, functional groups 304, and/or swing-responsive moieties 302.

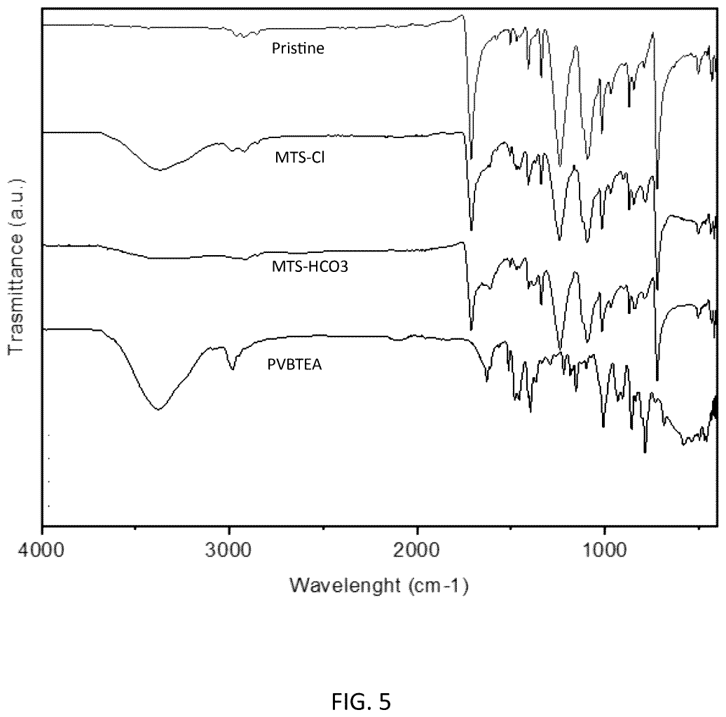

FIG. 5 shows the Infrared-Attenuated Total Reflectance Spectroscopy (IR-ATR) transmittance of non-limiting examples of pristine acrylic fabric (i.e., woven material 102), MTS-CI, MTS-HCO₃, and PVBTEA. As shown, the presence of the sorbent polymer 104 in the fabric is confirmed, as bands corresponding to the quaternary ammonium functional group 304 can be detected after modification, while said bands are not present in the transmittance of the pristine fabric.

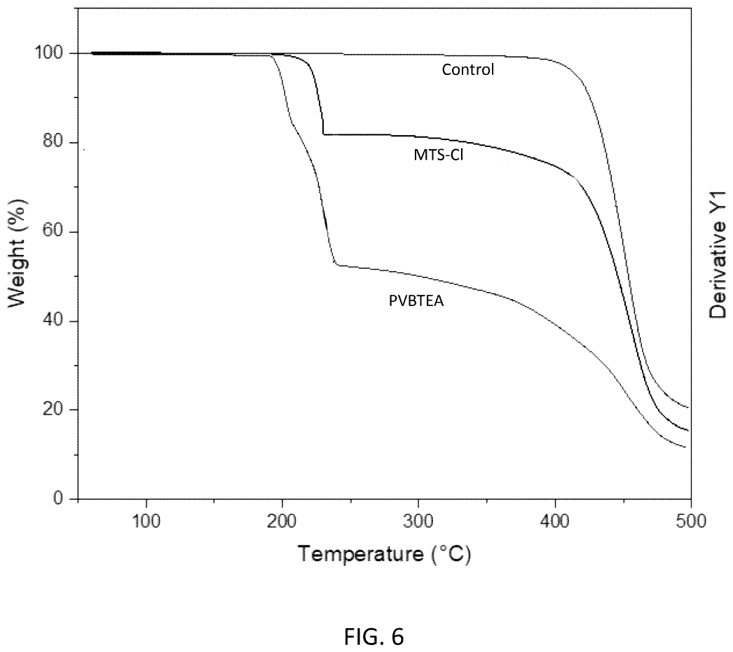

The thermal properties of the materials were tested using thermogravimetric analysis (TGA) and differential scanning calorimetry (DSC). FIG. 6 shows thermogravimetric analysis (TGA) results for the non-limiting examples of pristine fabric, the MTS-Cl, and PVBTEA discussed with respect to FIG. 5. In the TGA results it can be seen that the unbounded polymeric network (i.e., PVBTEA) has a temperature of degradation (Td5%) at 198° C. with a second drop at 230° C., which corresponds to the loss of the quaternary ammonium functional groups 304. Nevertheless, in MTS-CI, where the sorbent polymer 104 is immobilized into the woven material 102, the Td5% is at 223° C. which corresponds to 25° C. more than the sorbent by itself. The polymer degrades faster by itself compared to the polymer immobilized within the woven material. From the TGA data the amount of sorbent taken into MTS-Cl can be calculated, and is found to be around 17±3%. This means that the total number of carbon capture sites is lower than expected, according to the degree of modification obtained by difference in weight, suggesting that solvent or any other byproduct gets immobilized into the fibers. For all materials examined, including the pristine acrylic backing, the Td until residual is at 457° C.

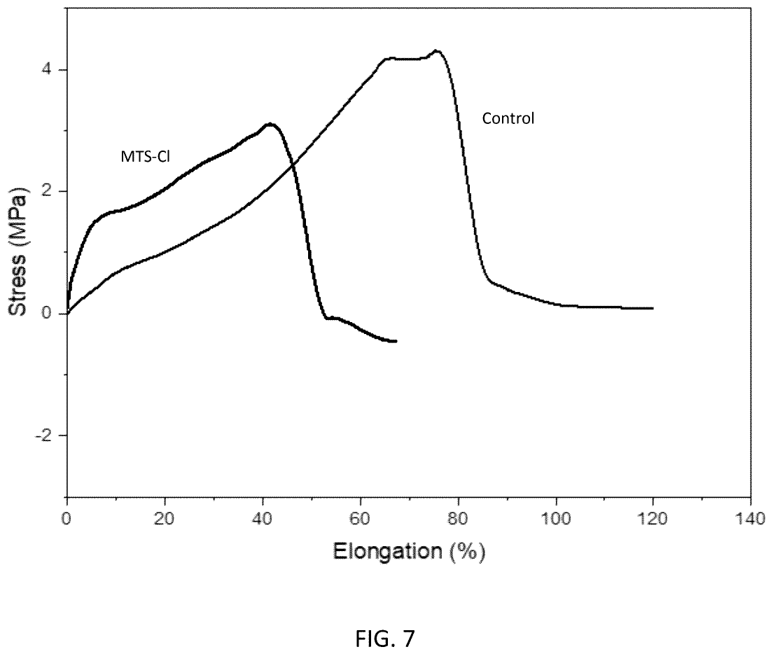

FIG. 7 shows the stress-strain behavior of the non-limiting examples of pristine woven material 102 and MTS-Cl discussed with respect to FIGS. 5 and 6. From this stress vs elongation (%) curve it can be inferred that MTS-Cl has a higher young's modulus than the control fabric, around 26.4 MPa compared to around 6.57 MPa, when lower stress is applied. It also shows the modified fabric is stiffer, but only while the applied stress is less than 2 MPa. The control fabric had a lower young's modulus; it retains its elastic properties for a high range of pressure, almost double that of the modified textile sorbent.

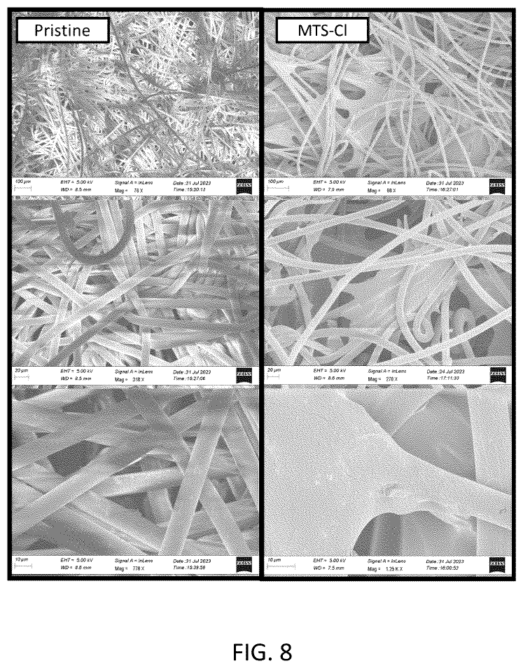

A morphological analysis was also performed, using scanning electron microscopy (SEM). FIG. 8 shows SEM images of the non-limiting examples of pristine woven material 102 and MTS-Cl discussed with respect to FIGS. 5-7. As shown, the sorbent is immobilized between the fibers of the acrylic-based fabric, where the well-defined fibers got stacked by the polymer into the free spaces.

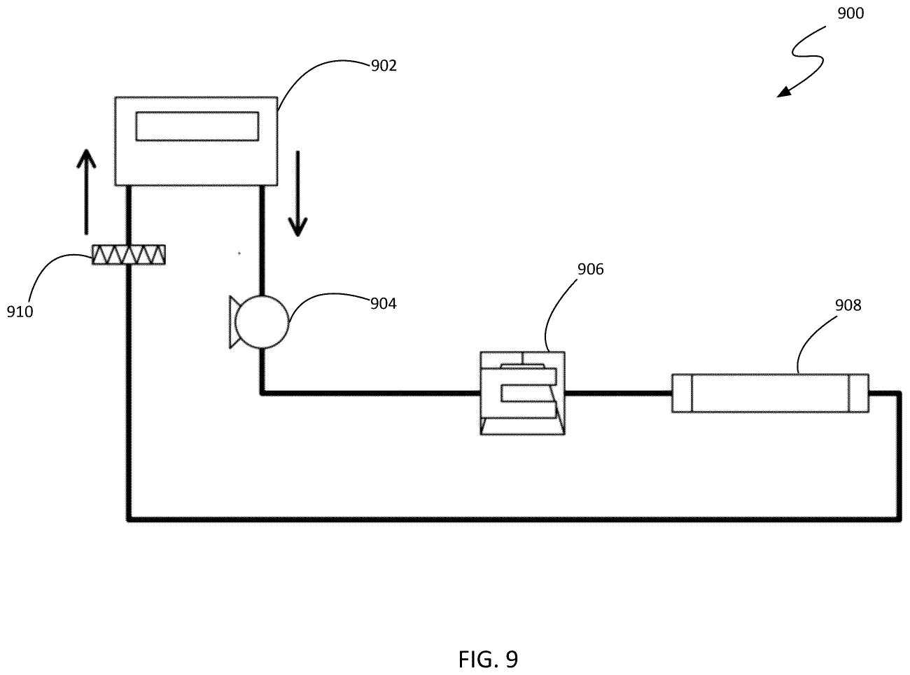

The performance of this specific, non-limiting example of the MTS material 100 in a DAC setting was also examined. All synthesized materials were stored in a humidity chamber to maintain a consistent CO₂ and water vapor loading. The DAC performance was quantified using a closed-circuit, humidity swing CO₂ adsorption-desorption system 900 shown in FIG. 9. The system 900 consists of an infrared gas analyzer 902 (i.e., LiCOR LI850), a pump 904, a custom dew point generator 906, and a sample tube 908. The pump 904 circulates 118 mL of air throughout the system 900. The air passes through the dew point generator 906, where a thermoelectric device can raise or lower humidity levels by heating or cooling a heat sink. The air then passes through the synthesized materials in the sample tube 908, and the changes in CO₂ and water vapor concentration are measured using the IRGA 902. These experiments were performed in ambient conditions, with starting CO₂ concentrations around 420-460 ppm and temperatures in the range of 23-25° C.

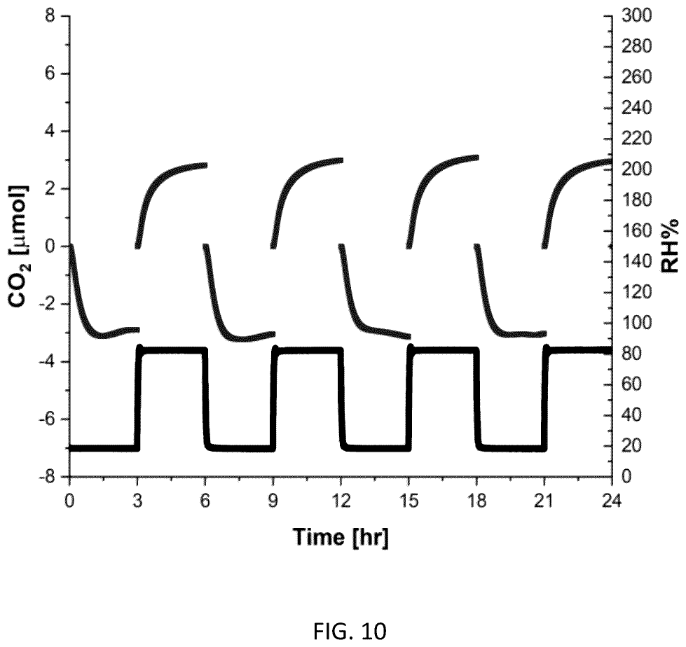

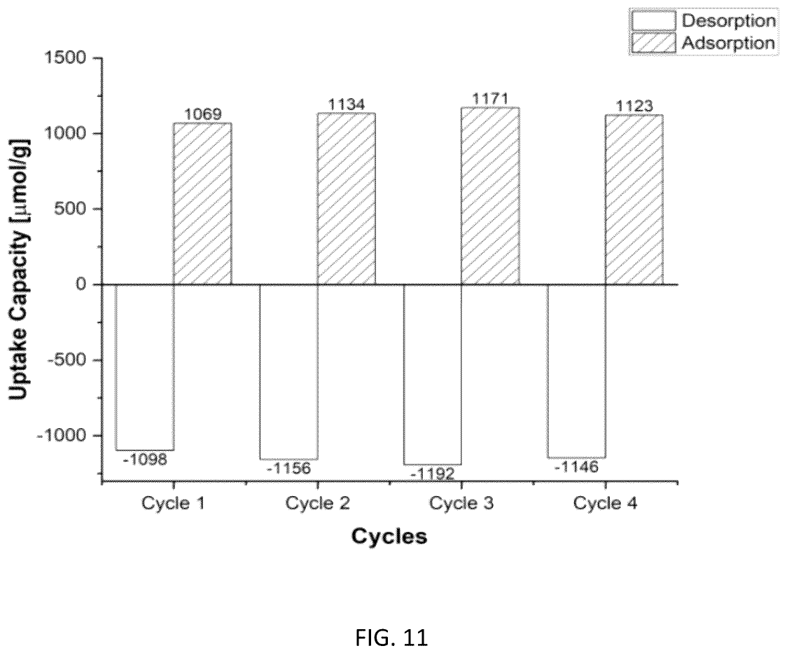

FIG. 10 shows CO₂ adsorption and desorption performance of a non-limiting example of an MTS material 100 observed with the closed-circuit DAC system of FIG. 9. Approximately 16 mg (3 mg active DAC mass) was loaded into the sample chamber, and the humidity cycled between 19 (dry) and 82 (wet) relative humidity (RH) percent for 3 hours at each set point. After an hour of dry exposure, the sorbent captured about 3 μmols of CO₂. An average uptake capacity of 1125±42 μmol/g was measured over 4 cycles, as shown in FIG. 11.

It will be understood that implementations are not limited to the specific components disclosed herein, as virtually any components consistent with the intended operation of a modified textile sorbent material and method for making the same may be utilized. Accordingly, for example, although particular systems, methods, and/or devices for the direct capture of atmospheric carbon dioxide may be disclosed, such components may comprise any shape, size, style, type, model, version, class, grade, measurement, concentration, material, weight, quantity, and/or the like consistent with the intended operation of a modified textile sorbent material and method for making the same may be used. In places where the description above refers to particular implementations of a modified textile sorbent material and method for making the same, it should be readily apparent that a number of modifications may be made without departing from the spirit thereof and that these implementations may be applied to other modified textile sorbent materials and methods.

What is claimed is:

1. A method for producing a sorbent material for CO₂ capture, comprising:
mixing a monomer of at least one sorbent polymer, in solution, with a woven material such that the monomer is impregnated into the woven material;
immobilizing the at least one sorbent polymer within the woven material by polymerizing the monomer of the at least one sorbent polymer that is impregnated into the woven material; and
substituting a counterion of each sorbent polymer of the at least one sorbent polymer with a swing-responsive moiety;
wherein the monomer of each sorbent polymer of the at least one sorbent polymer is one of styrene-based, acrylate-based, methacrylate-based, silicone-based, or polysulfone-based.

2. The method of claim 1, wherein the swing-responsive moiety responds to at least one of a temperature swing, a pressure swing, and a moisture swing.

3. The method of claim 1, wherein the counterion is one of chloride, bromide, and iodide.

4. The method of claim 1, wherein the swing-responsive moiety is one of carbonate and phosphate.

5. The method of claim 1, wherein the monomer of the at least one sorbent polymer comprises at least one of a quaternary ammonium functional group, a phosphonium functional group, and an imidazolium functional group.

6. The method of claim 1, wherein the woven material is hydrophobic.

7. The method of claim 6, wherein the woven material is acrylic fabric.

8. The method of claim 1, wherein the monomer is VBTEA.

9. The method of claim 1, wherein the woven material comprises at least one of polyester, polyacrylate, polyamide, and cotton.

10. A method for producing a sorbent material for CO₂ capture, comprising:
mixing a monomer of a sorbent polymer, in solution, with a woven material such that the monomer is impregnated into the woven material;
immobilizing the sorbent polymer within the woven material by polymerizing the monomer that is impregnated into the woven material; and
substituting a counterion of the sorbent polymer with a swing-responsive moiety that responds to a moisture swing;
wherein the counterion is chloride; and
wherein the monomer of the sorbent polymer is styrene-based and comprises a quaternary ammonium functional group.

11. The method of claim 10, wherein the woven material is hydrophobic.

12. The method of claim 11, wherein the woven material is acrylic fabric.

13. The method of claim 10, wherein the monomer is VBTEA.

14. The method of claim 10, wherein the woven material comprises at least one of polyester, polyacrylate, polyamide, and cotton.

15. A sorbent material for CO₂ capture, comprising:
a woven material; and
at least one sorbent polymer immobilized within the woven material, the at least one sorbent polymer comprising a plurality of swing-responsive moieties that respond to at least one of a temperature swing, a pressure swing, and a moisture swing.

16. The sorbent material of claim 15, wherein the at least one sorbent polymer comprises at least one of a plurality of quaternary ammonium functional groups, a plurality of phosphonium functional groups, and a plurality of imidazolium functional groups.

17. The sorbent material of claim 15, wherein the woven material is hydrophobic.

18. The sorbent material of claim 17, wherein the woven material is acrylic fabric.

19. The sorbent material of claim 15, wherein a monomer of the at least one sorbent polymer is VBTEA.

20. The sorbent material of claim 15, wherein the woven material comprises at least one of polyester, polyacrylate, polyamide, and cotton.
